(19) United States
(12) Patent Application Publication
(10) Pub. No.: US 2006/0134587 A1
(43) Pub. Date: Jun. 22, 2006

(54) Apparatus and method for processing braille information, process sheet, program, and storage medium

(75) Inventor: Masao Akaiwa, Shiojiri-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/314,797

(22) Filed: Dec. 20, 2005

(30) Foreign Application Priority Data
Dec. 22, 2004 (JP) 2004-371911

(51) Int. Cl. G09B 21/00; G06F 17/28; G06F 17/21

(52) U.S. Cl. 434/114; 704/3; 704/10

(57) ABSTRACT

A braille-information-processing apparatus includes a sign-storing device that stores a plurality of kinds of signs for sighted people, the signs being classified into a plurality of categories in accordance with the use of the signs and stored in association with the corresponding categories, a braille-information-storing device that stores braille information of a braille string representing a common expression that corresponds to each sign in each category, the braille information being stored in association with the corresponding sign and category, a sign-selecting device that selects one of the categories and one of the signs belonging to the selected category, and a presenting device that presents the braille information corresponding to the selected sign.

The entire disclosure of Japanese Patent Application No. 2004-371911, filed Dec. 22, 2004, is expressly incorporated by reference herein.

### BACKGROUND

1. Technical Field

The present invention relates to an apparatus and a method for processing braille information, a process sheet, a program, and a storage medium.

2. Related Art

When a sighted person makes a braille sheet (a braille tape, a braille label, etc.), the sighted person inputs a string of ink characters (hereafter simply called an “ink character string”) in the form of kana characters (Japanese phonetic characters) corresponding to braille characters based on the braille specifications. Then, braille information (braille data, such as braille cell image data) is obtained by converting the ink character string into a string of braille characters (hereafter simply called a “braille string”). Such a method is disclosed in, for example, Japanese Utility Model No. 3,054,580. In addition, in a particular field or industry, such as banking, character-string input keys or the like are assigned to typical, frequently-used ink character strings, such as “balance”, “deposit”, and “transfer”, and braille strings corresponding to these typical ink character strings are obtained by operating the input keys. Such a method is disclosed in, for example, Japanese Utility Model No. 3,055,310.

On the other hand, sighted people see various signs in daily life. For example, “open” and “close” signs on buttons for opening and closing doors and a sign representing “telephone” can be seen in elevators. A similar “telephone” sign can also be seen in stations and other public facilities (see the column “sign” in FIG. 10). However, there are no braille signs that directly correspond to the signs for sighted people. Therefore, these signs are necessarily expressed by braille strings corresponding to commonly used expressions (hereafter called “common expressions”) representing the meanings of the signs (see the column “reading” in FIG. 10).

However, sighted people generally do not have correct knowledge of braille specifications, let alone common expressions of braille strings. For example, when braille strings corresponding to the above-mentioned “open” and “close” signs are to be made, various expressions can be conceived. For example, in kana characters, “a-ke-ru”, “hi-ra-ku”, “ka-i”, etc., may be used for expressing the “open” sign, and “shi-me-ru”, “to-ji-ru”, “he-i”, etc., may be used for expressing the “close” sign. Therefore, it is difficult to select the appropriate expressions. In addition, similar signs may correspond to different common expressions depending on the places and conditions of use. For example, a “telephone” sign may be expressed as “ki-n-kyu”, which means emergency, or “de-n-wa”, which literally means a telephone, depending on the use thereof. Accordingly, it is difficult to learn the common expressions in association with the signs. For the above-described reasons, it is extremely difficult to make braille labels of braille strings corresponding to signs for sighted people by inputting ink character stings of common expressions.

### SUMMARY

An advantage of the invention is that it provides an apparatus and a method for processing braille information, a process sheet, a program, and a storage medium that allow even sighted people who do not have knowledge of braille specifications and common braille expressions to acquire braille information of braille strings representing common expressions that correspond to signs for sighted people in accordance with the use thereof.

According to an aspect of the invention, a braille-information-processing apparatus includes a sign-storing device that stores a plurality of kinds of signs for sighted people, the signs being classified into a plurality of categories in accordance with the use of the signs and stored in association with the corresponding categories; a braille-information-storing device that stores braille information of a braille string representing a common expression that corresponds to each sign in each category, the braille information being stored in association with the corresponding sign and category; a sign-selecting device that selects one of the categories and one of the signs belonging to the selected category; and a presenting device that presents the braille information corresponding to the selected sign.

According to another aspect of the invention, a method for processing braille information includes storing a plurality of kinds of signs for sighted people, the signs being classified into a plurality of categories in accordance with the use of the signs and stored in association with the corresponding categories; storing braille information of a braille string representing a common expression that corresponds to each sign in each category, the braille information being stored in association with the corresponding sign and category; selecting one of the categories and one of the signs belonging to the selected category; and presenting the braille information corresponding to the selected sign.

Accordingly, various signs seen by sighted people in daily lives are classified into categories designating the use thereof, and a desired sign can be selected to acquire a common braille expression corresponding to the sign. Thus, the braille information of a braille string representing a common expression that corresponds to each sign in each category can be read out and presented. Therefore, even a sighted person who does not have knowledge of braille specifications and common braille expressions can acquire the braille information of braille strings representing common expressions that correspond to signs for sighted people in accordance with the use thereof (that is, depending on the categories to which the signs belong). In other words, the apparatus functions as if it is a “sign/common-braille-expression dictionary” that provides braille information of braille strings representing common expressions that correspond to signs for sighted people. In this case, similar or identical signs (for example, telephone signs) that belong to different categories are classified individually in the respective categories. Therefore, different common expressions can be retrieved by selecting the categories and signs. If a standard of common expressions is established, common expressions that comply with the standard can be provided by storing them in advance.

In the above-described braille-information-processing apparatus, the braille information preferably includes cell image information representing an arrangement of cells of the braille string.

Accordingly, a cell image of the braille string for each sign in each category can be recognized by presenting by presenting the braille information (cell image in this case).

In the above-described braille-information-processing apparatus, the presenting device preferably includes an embossing device that embosses the braille string on a process sheet on the basis of the cell image information.

In such a case, the braille information (cell image of braille characters) for each sign in each category can be recognized by checking the braille string embossed on the process sheet.

In the above-described braille-information-processing apparatus, the presenting device preferably includes a sign-printing device that prints the selected sign on the process sheet such that the sign and the embossed braille string are adjacent to or overlapped with each other.

According to a further aspect of the invention, a process sheet includes a sign printed thereon, the sign being selected from a plurality of signs for sighted people that are classified into a plurality of categories in accordance with the use of the signs and a braille string of a common expression corresponding to the printed sign, the braille string being embossed or printed such that the sign and the braille string are adjacent to or overlapped with each other.

Accordingly, the sign and the corresponding braille string on the process sheet can be easily recognized in association with each other.

The above-described process sheet preferably includes a base sheet having an adhesive layer on one side and a peel sheet that covers the adhesive layer, the sign and the braille string being arranged on the base sheet.

Accordingly, after recognizing the sign and the corresponding braille string on the process sheet, the base sheet can be separated from the peel sheet and be adhered at a desired location as a mixed label including the sign and the braille string.

In the above-described braille-information-processing apparatus, the process sheet preferably includes a base sheet having an adhesive layer on one side and a peel sheet that covers the adhesive layer. In addition, the braille-information-processing apparatus preferably includes a half cutter that cuts only the base sheet at a position between the embossed braille string and the printed sign.

In the above-described process sheet, preferably, only the base sheet is cut by a half-cut process at a position between the sign and the braille string.

In such a case, after recognizing the sign and the corresponding braille string on the process sheet, a portion of the base sheet including only the sign and a portion of the base sheet including only the braille string can be individually or simultaneously separated from the peel sheet and be adhered at a desired location (location that matches the category) as a sign label, a braille label, or a mixed label.

In the above-described braille-information-processing apparatus, the braille information preferably includes braille-transcription-character-string information representing a braille transcription character string that represents the reading of the braille string.

Accordingly, the reading of the braille string for each sign in each category can be recognized by presenting the braille information (braille transcription character string in this case). In addition, a braille sheet and the like corresponding to each sign in each category can be obtained by inputting the braille transcription character string in the form of an ink character string to an apparatus that can make a braille string and a braille sheet thereof on the basis of an ink character string.

In the above-described braille-information-processing apparatus, the presenting device preferably includes a braille-information display that displays the braille information on a display screen.

Accordingly, the braille information corresponding to each sign in each category can be recognized by checking the braille-information displayed on the display screen.

In the above-described braille-information-processing apparatus, the presenting device preferably includes a braille-information printer that prints the braille information on a process sheet.

Accordingly, the braille information corresponding to each sign in each category can be recognized by checking the braille information printed on the process sheet.

In addition, according to a still further aspect of the invention, a program causes the braille-information-processing apparatus to function or executes the method for processing the braille information. In addition, according to a still further aspect of the invention, a storage medium stores the program such that the program can be read by a program processing apparatus that is capable of processing the program.

Accordingly, the above-described braille-information-processing apparatus can be caused to function or the above-described method for processing the braille information can be executed. Therefore, by processing the program with the program processing apparatus or by executing the program read out from the storage medium, even sighted people who do not have knowledge of braille specifications and common braille expressions can acquire braille information of braille strings representing common expressions that correspond to signs for sighted people in accordance with the use thereof.

### BRIEF DESCRIPTION OF THE DRAWINGS

The invention will be described with reference to the accompanying drawings, wherein like numbers reference like elements.

FIG. 1 is a perspective view of a label-making apparatus according to an embodiment of the invention.

FIG. 2 is a perspective view of the label-making apparatus shown in FIG. 1 with its lid opened.

FIG. 3 is a block diagram illustrating a control system of the label-making apparatus shown in FIG. 1.

FIGS. 4A and 4B are diagrams, each illustrating six-dot braille cells and cross sections of projecting portions obtained by a braille embossing process.

FIGS. 5A and 5B are a plan view of an embossing unit and a sectional view of the embossing unit.

FIG. 6 is a diagram illustrating the manner in which a tape is conveyed through a braille-embossing section.

FIG. 7 is a flowchart showing the overall process performed by the label-making apparatus.

FIGS. 8A to 8C are diagrams, each illustrating a process mode shown in FIG. 7.

FIGS. 9A to 9C are diagrams, each illustrating an example of a tape width in the process shown in FIG. 7.

FIG. 10 is a diagram illustrating braille strings of common expressions corresponding to signs that are classified into groups in accordance with the use thereof.

FIG. 11 is a diagram illustrating operational steps performed in a symbol-to-braille transcription process according to first and second examples.

FIG. 12 is a diagram illustrating operational steps performed after those shown in FIG. 11.

FIG. 13 is a diagram illustrating operational steps performed after those shown in FIG. 12.

FIG. 14 is a diagram illustrating operational steps performed after those shown in FIG. 13.

FIGS. 15A to 15D are diagrams, each illustrating a label that can be produced in first to sixth examples.

FIG. 16 is a diagram corresponding to FIG. 11 according to the third example.

FIGS. 17A to 17D are diagrams illustrating the fifth and sixth examples.

FIGS. 18A to 18D are diagrams, each illustrating a label according to the sixth example.

### DESCRIPTION OF EXEMPLARY EMBODIMENT

A label-making apparatus (braille-information-processing apparatus) according to an embodiment of the invention will be described below with reference to the accompanying drawings.

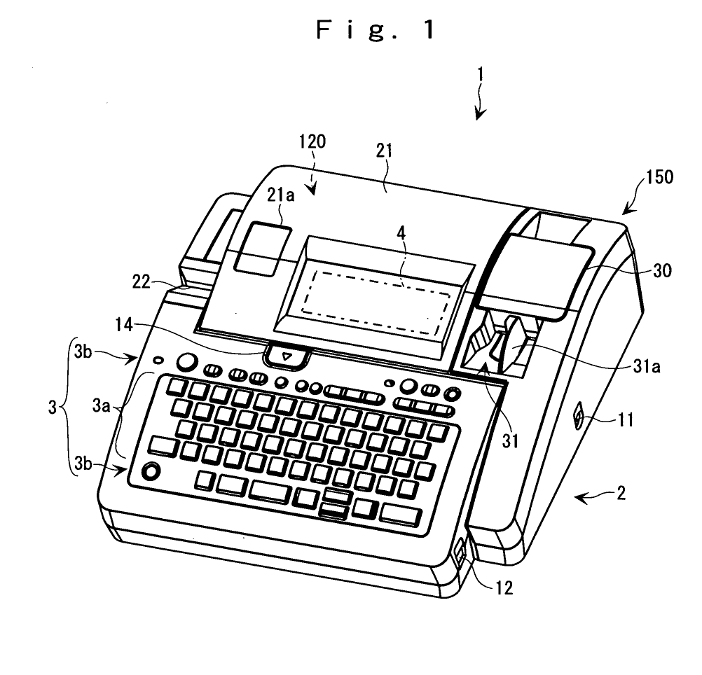

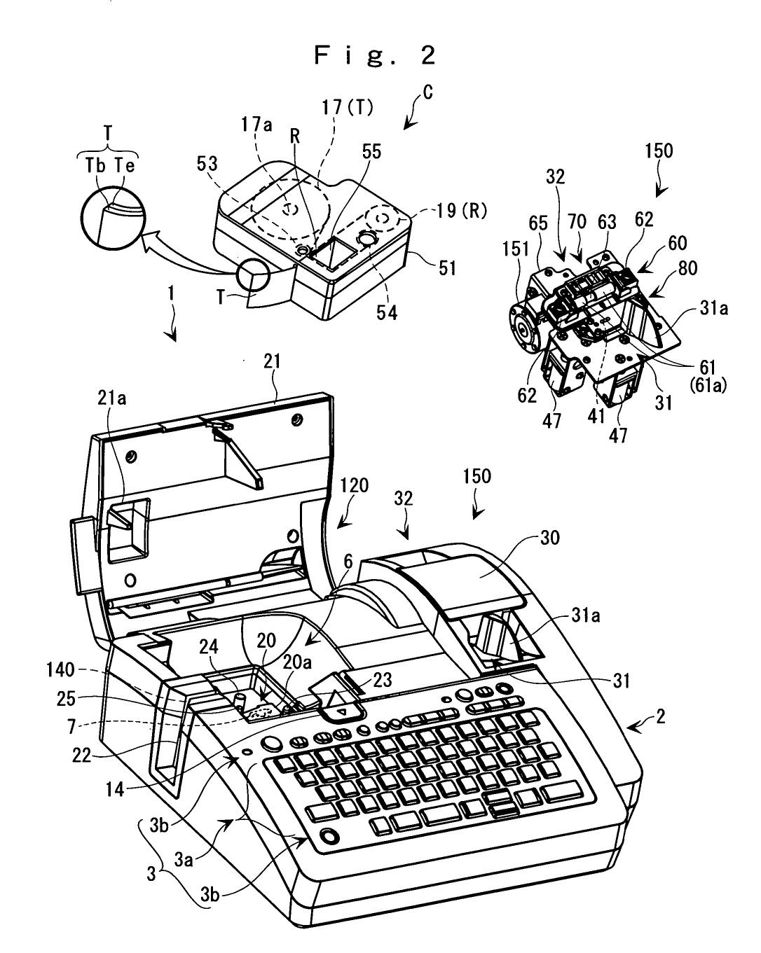

As shown in FIGS. 1 and 2, the label-making apparatus 1 includes a housing 2 that functions as an outer shell. The housing 2 has a keyboard 3 including various input keys on the top front surface thereof and an opening/closing lid 21 attached at the top rear surface thereof. The lid 21 has a rectangular display 4 on the front side.

An ink-character-printing section 120 that prints ink characters (letters, symbols, etc.) on a tape T fed from a tape cartridge C is disposed inside the lid 21. In addition, a cartridge-mounting section 6 for receiving the tape cartridge C is also provided inside the lid 21. The lid 21 opens when a lid-opening button 14 is pressed, and the tape cartridge C is detachably attached to the cartridge-mounting section 6 while the lid 21 is open. The lid 21 has a viewing window 21a so that a user can check whether or not the tape cartridge C is mounted without opening the lid 21.

An assembly for performing braille embossing (a braille-embossing section 150 shown at the upper right in FIG. 2) is installed in a space on the right of the lid 21 (i.e., the right back space in the housing 2). This assembly is covered with an embossing-section cover 30 at the top. An embossing-tape insertion slot 31 through which the user manually inserts the tape (process sheet) T is provided in front of the embossing-section cover 30, and an embossed-tape output slot 32 through which the tape T is output after the braille-embossing process is provided behind the embossing-section cover 30. The embossing-tape insertion slot 31 and the embossed-tape output slot 32 are inclined to form a downward slope along a tape conveying path (feed path) 70. In addition, a manual feed guide 32a that is adjustable along the width of the tape is disposed near the embossing-tape insertion slot 31.

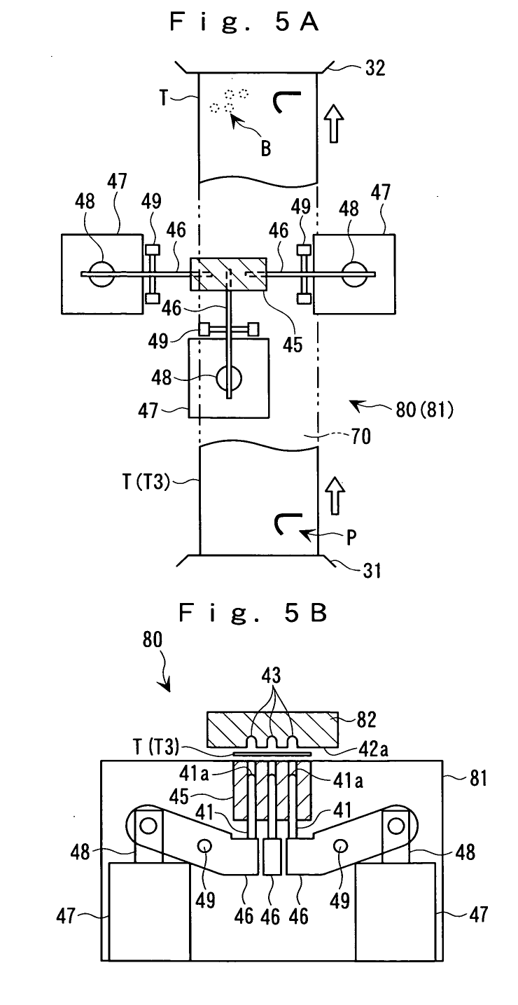

The braille-embossing section 150 includes an embossing unit 80 that performs braille embossing using three embossing pins (embossing head) 41 (see FIG. 5B); a tape feed unit (tape feed mechanism) 60 that conveys the tape T inserted through the embossing-tape insertion slot 31 to the embossed-tape output slot 32; and the tape conveying path 70 along which the tape T is conveyed. The embossing assembly is formed by attaching the above-mentioned units to a frame member 65 that defines the tape conveying path 70 and is integrally mounted to the housing 2. Braille characters B are formed by selectively driving the three embossing pins 41 with the embossing unit 80 while conveying the tape T along the tape conveying path 70 with the tape feed unit 60.

A power supply opening 11 for supplying electric power is formed in the right side of the housing 2 at the central region thereof. In addition, a connection opening (interface) 12 for providing connection to an external apparatus (not shown), such as a personal computer, is also formed in the right side of the housing 2 at a front region thereof. Accordingly, ink-character printing and braille embossing can be performed on the basis of character information provided from the external apparatus. A printed-tape output slot 22 through which the cartridge-mounting section 6 communicates with the outside is formed in the left side of the housing 2. A cutter section 140 for cutting the tape T output from the ink-character-printing section 120 is disposed so as to face the printed-tape output slot 22. The tape T is cut by the cutter section 140 so that the tape T can be output through the printed-tape output slot 22 after the ink-character-printing process.

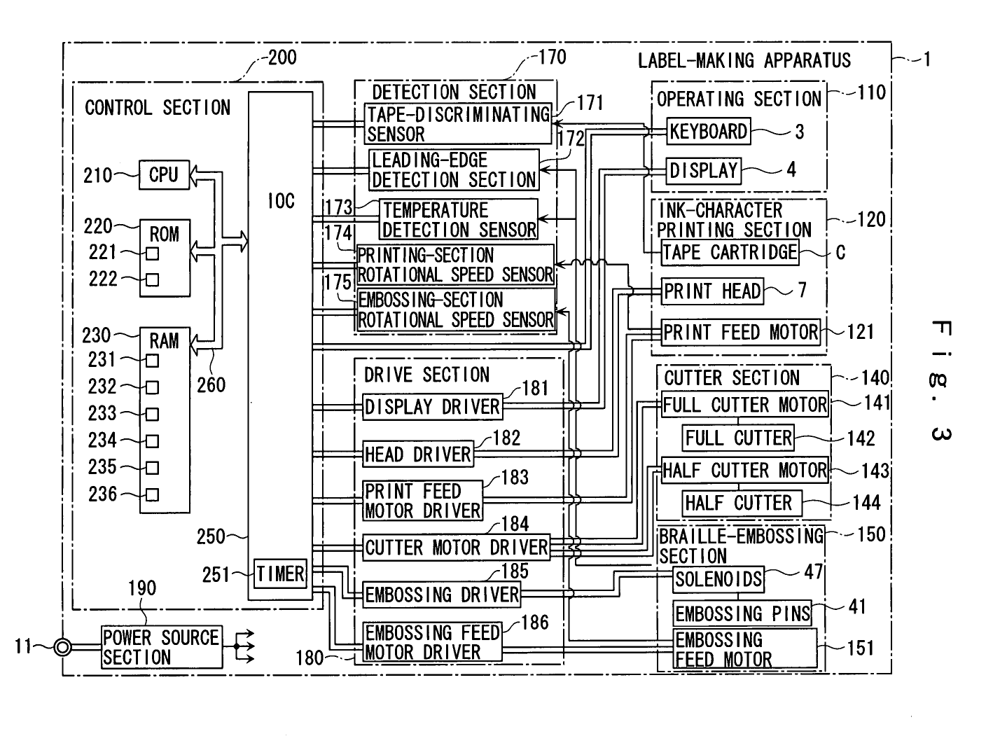

As shown in FIG. 3, the basic structure of a control system of the label-making apparatus 1 includes an operating section 110, the ink-character-printing section 120, and the cutter section 140. The operating section 110 includes the keyboard 3 and the display 4 and provides a man/machine interface for inputting character information and displaying various information. The ink-character-printing section 120 includes the tape cartridge C, a print head 7, and a print feed motor 121 and prints ink characters on the tape T while conveying the tape T and an ink ribbon R. The cutter section 140 includes a full cutter 142, a half cutter 144, a full-cutter motor 141 for driving the full cutter 142, and a half-cutter motor 143 for driving the half cutter 144 and cuts off the tape T after the ink-character-printing process.

The control system of the label-making apparatus 1 further includes the braille-embossing section 150 and a detection section 170. The braille-embossing section 150 includes solenoids 47, the embossing pins 41, and an embossing feed motor 151 and embosses braille characters on the tape T while conveying the tape T. The detection section 170 performs various detections using tape-discriminating sensors 171 that determine the kind of the tape T (tape cartridge C), a transmissive leading-edge detection sensor 172 that detects the leading edge of the tape T in the braille-embossing section 150, a temperature detection sensor 173 that detects the ambient temperature (environmental temperature) of the braille-embossing section 150, a printing-section rotational speed sensor 174 that detects the rotational speed of the print feed motor 121, and an embossing-section rotational speed sensor 175 that detects the rotational speed of the embossing feed motor 151.

The control system of the label-making apparatus 1 further includes a drive section 180, a power source section 190, and a control section 200. The drive section 180 drives each component with a display driver 181, a head driver 182, a print feed motor driver 183, a cutter motor driver 184, an embossing driver 185, and an embossing feed motor driver 186. The power source section 190 is connected to the power supply opening 11 to supply electric power to each component. The control section 200 is connected to each component and controls the overall operation of the label-making apparatus 1.

The control section 200 includes a central processing unit (CPU) 210, a read only memory (ROM) 220, a random access memory (RAM) 230, and an input/output controller (IOC) 250 which are connected to each other with an internal bus 260. The ROM 220 includes a control program block 221 that stores control programs for causing the CPU 210 to control various processes including the ink-character-printing process and the braille-embossing process and a control data block 222 that stores ink-character font data used in the ink-character printing process, braille font data used in the braille-embossing process, and control data used to control the braille-embossing process.

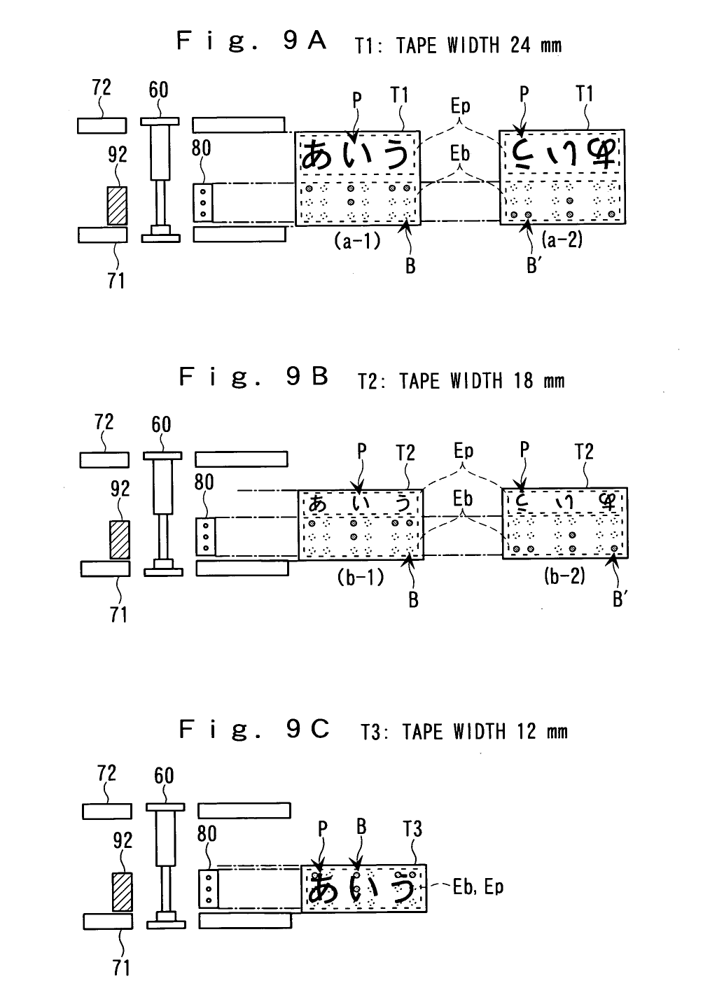

The RAM 230 functions as work areas for the control processes and includes a flag area block 231 used as a generic flag, a register, etc.; an ink-character data block 232 that stores ink-character information including text data of ink character strings and ink-character image data; a braille data block 233 that stores braille information including text data of braille strings, cell-image data, braille image data, inverted braille image data B′ (see FIGS. 9A and 9B) obtained by inverting the braille image data by 180°; a display data block 234 that stores display image data to be displayed on the display 4; a layout block 235 that stores layouts of ink-character printing areas (printing arrangement sections) Ep and braille-embossing areas (embossing arrangement sections) Eb; and a work area block 236 used as other various generic work areas. The RAM 230 is continuously backed up so that data stored therein can be retained after the power is turned off.

The IOC 250 includes logic circuits including gate arrays and custom large-scale integrated (LSI) circuits to complement the function of the CPU 210 and process interface signals obtained from peripheral circuits. For example, a timer 251 for measuring times by counting a basic clocking signal is included in the IOC 250. The IOC 250 receives input data and control data from the keyboard 3 and sensor outputs from the detection section 170, and transmits the received data and outputs to the internal bus 260 directly or after processing them. In addition, the IOC 250 operates in association with the CPU 210 to receive data and control signals output to the internal bus 260 by the CPU 210, and outputs the received data and signals to the drive section 180 directly or after processing them.

The CPU 210 receives various signals and data from each component of the label-making apparatus 1 via the IOC 250, processes various data stored in the RAM 230 on the basis of the received signals and data, and outputs various signals and data to each component of the label-making apparatus 1 via the IOC 250 under the control of the control programs stored in the ROM 220, thereby controlling the ink-character-printing process, the braille-embossing process, etc.

For example, when character information, such as ink-character-string text data, is input from the keyboard 3, the CPU 210 creates ink characters (image data) P and braille characters (image data) B on the basis of the character information. Then, the CPU 210 adjusts the length and the like between the image data of ink characters and the image data of braille characters and prepares the inverted braille characters (image data) B′ (see FIGS. 9A and 9B) as necessary. In addition, the CPU 210 stores the ink characters (image data including margin data) P before or after the adjustment in the ink character data block 232. Similarly, the CPU 210 stores the braille characters (image data including margin data) B and the inverted braille characters (image data) B′ before or after the adjustment in the braille data block 233.

In addition, when the CPU 210 receives an ink-character-printing command or a braille-embossing command from the keyboard 3, the CPU 210 starts driving the print feed motor 121 and drives the print head 7 in accordance with the detection result obtained by the printing-section rotational speed sensor 174, thereby printing the ink characters P. Then, the tape T is fed by the length adjusted as necessary, is cut at the trailing end thereof by the full cutter 142, and is output through the printed-tape output slot 22.

Then, referring to FIGS. 1 to 3, the user manually inserts the tape T cut into a strip shape into the embossing-tape insertion slot 31 without resetting or turning off the power. Accordingly, the embossing unit 80 and the tape feed unit 60 are driven so as to emboss the braille characters B (or the inverted braille characters B′). After the braille-embossing process, the embossing feed motor 151 is driven to convey the tape T having the length adjusted as necessary, so that the tape T is output from the embossed-tape output slot 32.

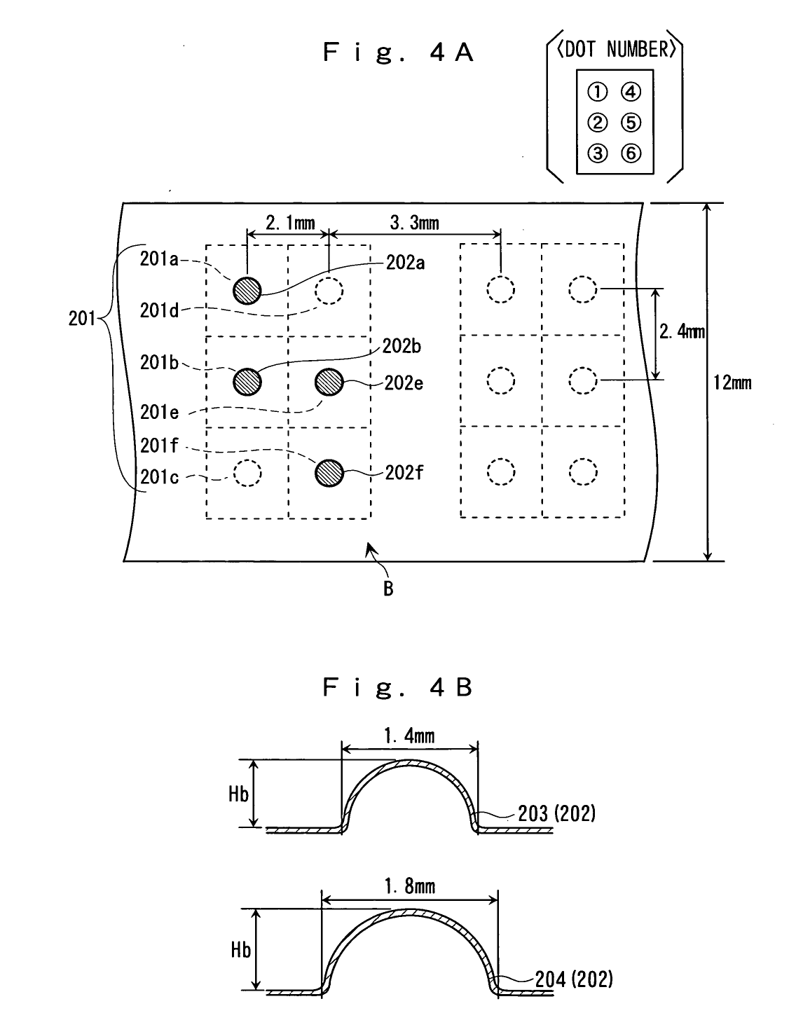

The braille characters B (six-dot braille characters) formed on the tape T will be described with reference to FIGS. 4A and 4B.

First, specifications of each character (cell) and an interval between characters (cells) commonly used in braille slates and braille typewriters (hereafter called “commercial specifications”) will be described. As shown in FIG. 4A, a single six-dot braille character B is defined by a cell 201 including six dots arranged in two columns and three rows (first to sixth dots shown at the upper right in FIG. 4A). The cell 201 represents a character, a dakuten symbol (Japanese voiced sound symbol), or other attributes in accordance with a pattern formed by selectively embossing or not embossing the dots. For example, in the cell 201 shown in FIG. 4A, the first, second, fifth, and sixth dots are embossed, and the third and fourth dots are not embossed. Accordingly, the braille character B defined by this cell 201 indicates the kana character “si” (Japanese symbol character).

In each six-dot braille character B, the cell 201 includes six embossing points 201a to 201f arranged in two columns and three rows with a vertical pitch of about 2.4 mm and a horizontal pitch of about 2.1 mm. A pitch between the cells is about 3.3 mm. In FIG. 4A, dots are embossed at four embossing points 201a, 201b, 201e, and 201f selected from the six embossing points 201a to 201f, so that the cell 201 represents the kana character “si”. As a result of the embossing process, four projecting portions 202a, 202b, 202e, and 202f having a cylindrical, a semispherical, a conical, or a quadrangular pyramid shape with rounded corners (see FIG. 4B) are formed on the tape T. In order to emboss the six-dot braille character B, the width of the tape must be at least 12 mm (tape T3, which will be described below), as calculated from the size of the cell 201 along the width of the tape T.

Two kinds of replaceable units are prepared to be used as the embossing unit 80 in the label-making apparatus 1. Referring to FIG. 4B, one of the units forms a small projecting portion 203 with a diameter of about 1.4 mm, and the other unit forms a large projecting portion 204 with a diameter of about 1.8 mm. The projecting portions 203 and 204 are selectively formed depending on the use thereof. For example, the small projecting portion 203 may be used for people skilled in reading braille characters B (e.g., for congenitally blind people) and the large projecting portion 204 may be used for beginners (e.g., for adventitiously blind people). In addition, the height Hb of the projecting portions may be adjusted (changed) depending on the use or preference irrespective of the diameter of the projecting portions.

In addition to the above-described six-dot braille characters B representing kana characters, numbers, etc., eight-dot braille characters defined by cells including eight dots arranged in two columns and four rows are used to express kanji characters (Japanese ideographic characters). Although the present embodiment is described using the six-dot braille characters B as an example, the invention may also be applied to label-making apparatuses for forming eight-dot braille characters. In the braille characters that are obtained in practice by the embossing process, the embossed dots are formed as the projecting portions, whereas the non-embossed dots are simply flat sections that cannot be viewed. However, in the drawings referred to in the present embodiment, the embossed dots are shown as hatched circles drawn with solid lines and the non-embossed dots are shown as white-filled circles drawn with dashed lines for convenience.

The label-making apparatus 1 will be described in more detail below with reference to FIGS. 1 to 3. Character keys 3a and function keys 3b for designating various operation modes are arranged on the keyboard 3. The character keys 3a have a full key pattern based on Japanese Industrial Standards (JIS) key arrangement, and used to input character information for ink-character printing and braille embossing. Similar to common word processors and the like, the function keys 3b include a kana/kanji conversion key, a cancel key for canceling processes, a cursor key for moving a cursor, a confirmation (Enter) key for selecting an item on various selection screens or starting a new line in a text input process, and a symbol key for reading out simple diagrams and symbols.

The function keys 3b further include a print/execute key (print key) for executing the ink-character-printing process or the braille-embossing process, a feed start key for issuing a command to start feeding the tape T in the braille-embossing section 150, an embossing start key for manually starting the braille-embossing process, a mode key for selecting a process mode in the ink-character-printing process or the braille-embossing process, a layout key for setting a layout of the ink-character printing area (printing arrangement section) Ep and the braille-embossing area (embossing arrangement section) Eb, a preview key for displaying a preview of the result of layout before printing, a scroll key for scrolling the display, a braille input key for inputting and editing braille information, a braille transcription key for generating an intermediate character string (braille transcription character string) when a normal character string, such as an ink character string, is transcribed or when a braille cell is read out, and an environment key for setting processing environment including the print/display density, the embossing height.

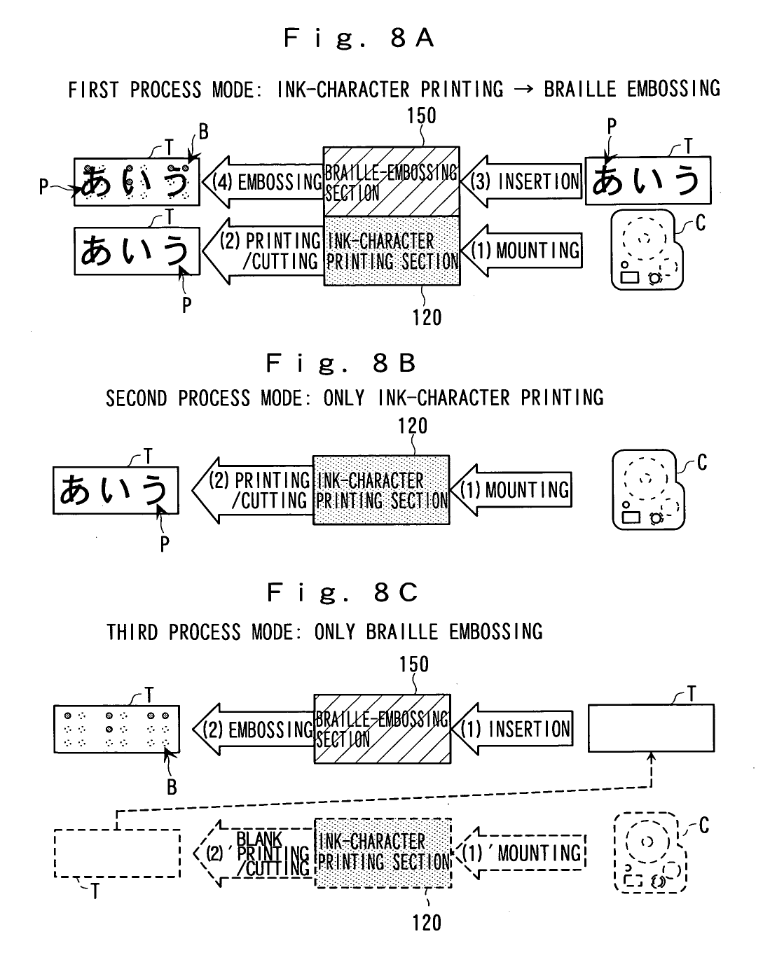

Process modes selected by the mode key include a first process mode in which ink-character printing and braille embossing are performed on the basis of the input character information (see FIG. 8A), a second process mode in which only ink-character printing is performed on the basis of the input character information (see FIG. 8B), and a third process mode in which only braille embossing is performed on the basis of the input character information (see FIG. 8C). One of these process modes is selected.

The display 4 has a rectangular shape of about 12 cm in the horizontal (X) direction and about 5 cm in the vertical (Y) direction and is capable of displaying an image of 192 dots×80 dots. The display 4 is used when the user inputs, creates, or edits information of ink and braille characters through the keyboard 3. The display 4 also informs the user of various errors and messages (commands).

In the ink-character-printing section 120, the cartridge-mounting section 6 includes a head unit 20 in which the print head 7 including a thermal head is mounted under a head cover 20a, a platen drive shaft 25 that faces the print head 7, a take-up drive shaft 23 for winding the ink ribbon R, and a positioning boss 24 for a tape reel 17. The platen drive shaft 25 and the take-up drive shaft 23 are rotated by the print feed motor 121 that is disposed under the cartridge-mounting section 6.

The tape cartridge C includes a cartridge case 51 containing the tape reel 17 and a ribbon reel 19. The tape T and the ink ribbon R have the same width. A through hole 55 for receiving the head cover 20a is formed in the tape cartridge C, and a platen roller 53 that engages with the platen drive shaft 25 to rotate together therewith is disposed at a position where the tape T and the ink ribbon R lie on top of each other. The ink ribbon R unwound from the ribbon reel 19 is pulled around the head cover 20a and is wound around a ribbon take-up reel 54 disposed near the ribbon reel 19.

When the tape cartridge C is mounted to the cartridge-mounting section 6, the head cover 20a, the positioning boss 24, the platen drive shaft 25, and the take-up drive shaft 23 are inserted into the through hole 55, a center hole 17a of the tape reel 17, the platen roller 53, and a center hole of the ribbon take-up reel 54, respectively. The print head 7 is pressed against the platen roller 53 with the tape T and the ink ribbon R disposed therebetween, so that ink-character printing can be performed. The tape T is conveyed to the printed-tape output slot 22 after the ink-character-printing process.

The tape T includes a base tape (base sheet; information layer) Tb having an adhesive agent layer (adhesive layer) on the back surface thereof and a peel tape (peel sheet: peel layer) Te adhered to the base tape Tb so as to cover the adhesive agent layer. The base tape Tb is formed by laminating an image-forming layer having improved fixing performance of ink that is thermally transferred from the ink ribbon R, a base layer composed of a polyethylene terephthalate (PET) film that is the major portion of the base tape Tb, and the adhesive agent layer composed of adhesive agent, in that order from the front side. The peel tape Te protects the adhesive agent layer from dust and the like until the base tape Tb is used as a label and is composed of high-quality paper having a siliconized surface (PET paper is used is this embodiment).

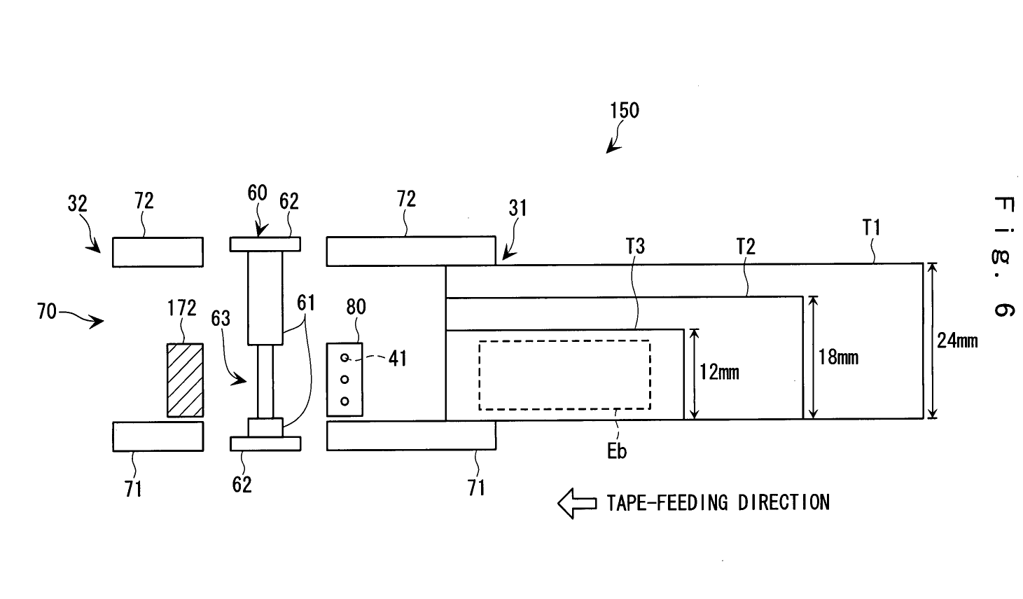

A plurality of kinds of tapes with different widths, colors, ink colors, materials, etc., are prepared to be used as the tape T, and the cartridge case 51 has a plurality of holes (not shown) indicating the kind of the tape contained therein in the back surface thereof. A plurality of tape-discriminating sensors (microswitches) 171 for detecting the holes formed in the cartridge case 51 are provided in the cartridge-mounting section 6 at positions corresponding to the holes. Accordingly, the kind of the tape can be determined from the result of detection of the tape-discriminating sensors 171. In the present embodiment, three kinds of tapes are used: tape T1 with a width of 24 mm, tape T2 with a width of 18 mm, and tape T3 with a width of 12 mm (see FIG. 6).

Although not shown in detail in the figure, the full cutter 142 included in the cutter section 140 is of a sliding type and has a slanted cutting edge that slides vertically to cut the tape T. The cutting edge (cutter holder) is caused to slide along the width of the tape T by a crank mechanism having the full cutter motor 141 as a drive source. As the cutting edge slides, both the base tape Tb and the peel tape Te are cut; in other words, the tape T is fully cut.

Similarly, the half cutter 144 is of a sliding type and has a slanted cutting edge that has substantially the same shape as that of the full cutter 142. The half cutter 144 is disposed upstream of the full cutter 142 in the tape-feeding direction (that is, closer to the tape cartridge C), and is caused to slide along the width of the tape T by a crank mechanism having the half cutter motor 143 as a drive source. Different from the full cutter 142, the amount of projection of the cutting edge of the half cutter 144 is adjusted such that only the base tape Tb can be cut. Accordingly, as the cutting edge slides, only the base tape Tb that faces the cutting edge is cut; in other words, the tape T is half-cut.

As shown in FIG. 5B, in the braille-embossing section 150, the embossing unit 80 includes an embossing member (embossing head) 81 disposed behind the tape T and having the above-mentioned three embossing pins 41 and a receiving member 82 disposed at a position where the receiving member 82 faces the embossing member 81 with the tape T disposed therebetween to receive the embossing pins 41 that move upward in the embossing process. The embossing unit 80 is fixed at a position under the tape conveying path 70 (i.e., at the bottom in FIG. 5B).

In the embossing member 81, the three embossing pins 41 are arranged along the width of the tape (along the horizontal direction in FIG. 5B) with a pitch of 2.4 mm. The embossing pins 41 correspond to three dots 201a to 201c (or 201d to 201f) arranged vertically in the braille cell including six dots. The embossing pins 41 are held perpendicularly to the tape T by a guide member 45 that guides the liner motion of the embossing pins 41, and are driven by the corresponding solenoids 47. Each embossing pin 41 has a head portion 41a that is shaped such that the head portion 41a can form a projecting portion 202 having a cylindrical, a semispherical, a conical, or a quadrangular pyramid shape with rounded corners (see FIG. 4B).

The solenoids 47 causes plungers 48 to move linearly, and accordingly arm members 46 rotate around support members 49. As a result, the embossing pins 41 move linearly in the direction perpendicular to the tape T. The three solenoids 47 connected to the respective arm members 46 are arranged at the vertices of a triangle. The receiving member 82 has three pin-receiving recesses 43 for receiving the three embossing pins 41 in a surface 42a facing the three embossing pins 41. The embossing pins 41 and the receiving member 82 form the projecting portions 202 on the tape T. The surface 42a that faces the three embossing pins 41 may also be formed as a flat surface made of elastic material, such as synthetic rubber, instead of forming the receiving recesses 43.

As shown in FIG. 6, the tape feed unit 60 includes a feed roller pair 61, a support member 62 that supports the feed roller pair 61 on the frame member 65, and the embossing feed motor 151 (see FIG. 3) that rotates the feed roller pair 61 in forward and reverse directions. The feed roller pair 61 is a grip roller unit including a drive roller (not shown) and a driven roller 61a, and the driven roller 61a has an annular groove 63 so that the braille characters B are prevented from being smashed by the driven roller 61a.

The tapes T1, T2, and T3 having the width of 24 mm, 18 mm, and 12 mm, respectively, can be inserted into the embossing-tape insertion slot 31. The tape T1 with the largest width is guided by upper and lower guides 72 and 71, and the other tapes T2 and T3 are guided only by the lower guide 71. Each of these tapes is manually inserted by the user until the leading edge thereof reaches the tape feed unit 60 (feed roller pair 61), that is, as deep as the tape can be inserted. The tape feed unit 60 starts feeding the tape when the feed start key on the keyboard 3 is pressed.

Detection of the leading edge of the tape T by the leading-edge detection sensor 172 serves as a trigger to start the braille-embossing process in which tape feeding and braille embossing are performed on the basis of the input braille data. If the distance from the leading edge of the tape T to the embossing start position is set to be shorter than the distance between the leading-edge detection sensor 172 and the embossing pins 41, the tape T is moved backward by rotating the feed roller pair 61 in reverse. Then, braille embossing and tape feeding in the forward direction are started after the tape T is moved back to an adequate position. Instead of using the detection of the leading edge of the tape T by the leading-edge detection sensor 172 as a trigger, the embossing unit 80 may also start the braille-embossing process when the embossing start key on the keyboard 3 is pressed by the user.

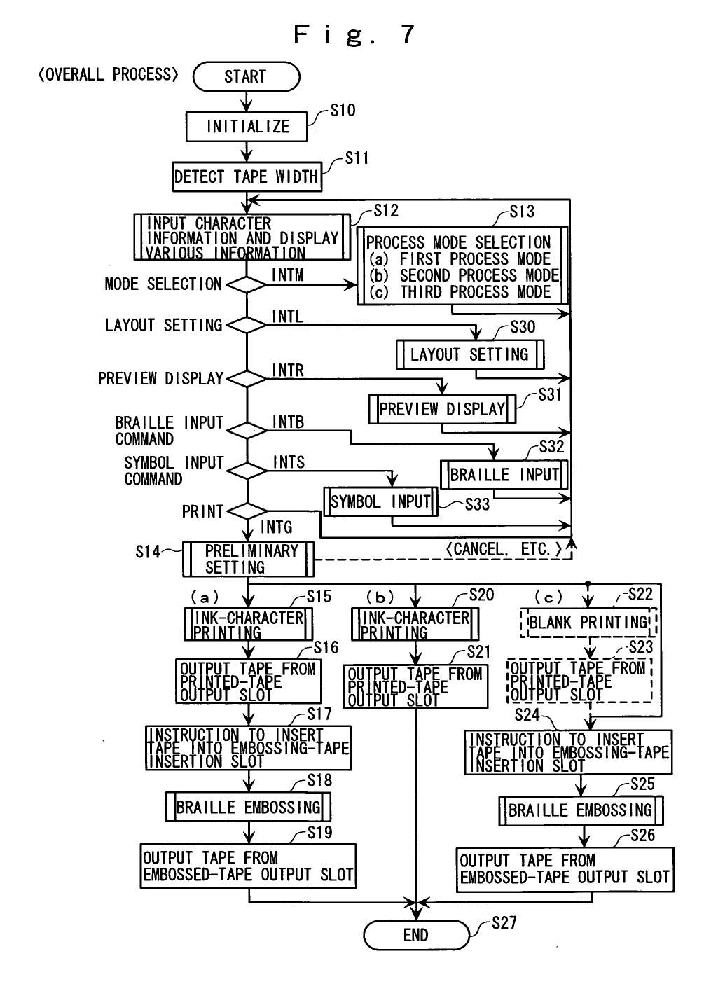

Next, the overall process performed by the label-making apparatus 1 will be described with reference to FIGS. 7, 8A to 8C, and 9A to 9C. As shown in FIG. 7, when a power key is pressed (power is turned on) to start the process, initialization (e.g., restoration of flags) to reestablish the state at the time when the power was turned off (S10). Then, the kind of the tape T is detected by the tape-discriminating sensors 171 shown in FIG. 3 (S11). Next, character information is input by the user through the keyboard 3 (or is transmitted from an external apparatus like a personal computer), and various information is displayed on an editing screen or the like (S12).

Then, when a mode selection command (mode key input) is obtained through the keyboard 3 or when a corresponding command is input from the external apparatus, a mode selection interruption (INTM) is generated. Accordingly, a process-mode-selecting step is executed and one of the first process mode (both ink and braille characters), the second process mode (only ink characters), and the third process mode (only braille characters) is selected (S13).

When a layout setting command (layout key input) is obtained or when a corresponding command is input from the external apparatus, a layout setting interruption (INTL) is generated and a layout setting step is executed (S30). When a preview display command (preview key input) is obtained or when a corresponding command is input from the external apparatus, a preview display interruption (INTR) is generated and a preview display step is executed (S31). When a braille input command (braille input key input) is obtained or when a corresponding command is input from the external apparatus, a braille input command interruption (INTB) is generated and a braille input step is executed (S32). When a symbol input command (symbol key input) is obtained or when a corresponding command is input from the external apparatus, a symbol input command interruption (INTS) is generated and a symbol input step is executed (S33). When a print/execution command (print key input) is obtained or when a corresponding command is input from the external apparatus, a print interruption (INTG) is generated and a preliminary setting step is executed (S14).

In the preliminary setting (S14), settings including the layout required when ink-character printing and braille embossing are performed are determined and final confirmation thereof is made. If the print interruption (INTG) is generated without the mode selection interruption, the layout setting interruption, the preview display interruption, the braille input command interruption, and the symbol input command interruption, the previously set mode is selected as a default. In the initial setting, the first process mode is selected, braille characters are set to be formed below and parallel to ink characters, and ink characters are set to be input. After the preliminary setting (S14), the ink-character-printing process and the braille-embossing process are started.

More specifically, as shown in FIGS. 7 and 8A, when the first process mode (a) is selected in the process-mode-selecting step (S13), the ink characters P are printed (ink-character printing is performed) by the ink-character-printing section 120 (S15), and then the tape T is cut and output from the printed-tape output slot 22 (S16). Then, an instruction to insert the tape T into the embossing-tape insertion slot 31 is displayed on the display 4 (S17). The instruction may also be displayed by an indicator or a light-emitting diode (LED).

In response to the instruction to insert the tape T, the user manually inserts the tape T into the embossing-tape insertion slot 31. Accordingly, the braille characters B are embossed (braille embossing is performed) by the braille-embossing section 150 (S18). Then, the tape T is output from the embossed-tape output slot 32 (S19), and the process is finished (S27).

When the second process mode (b) is selected in the process-mode-selecting step (S13), ink-character printing is performed by the ink-character-printing section 120 (S20), and then the tape T is cut and output (S21). Then, the process is finished (S27). As shown in FIG. 8B, in the second process mode, the tape T pulled out from the tape cartridge C is fed to the ink-character-printing section 120, where the ink characters P are printed.

When the third process mode (c) is selected in the process-mode-selecting step (S13), an instruction to insert the tape T into the embossing-tape insertion slot 31 is displayed on the display 4 (S24). Then, the user inserts the tape T and braille embossing is performed (S25). Then, the tape T is output from the embossed-tape output slot 32 (S26) and the process is finished (S27). As shown in FIG. 8C, in the third process mode, the tape T cut into a strip shape (in an arbitrary length) is manually inserted into the braille-embossing section 150, where the braille characters B are embossed.

In order to obtain the strip-shaped tape T to be manually input, as shown by the dashed lines in FIGS. 7 and 8C, blank printing (tape feeding without printing) may be performed (S22) instead of ink-character printing performed in the first mode before displaying the instruction to insert the tape T (S24). After blank printing, the tape T is cut and output (S23), and the thus output tape T is used as the strip-shaped tape T for manual insertion. In addition, although not shown in the figures, the apparatus may also be structured such that the tape cartridge C can be mounted at a position upstream of the braille-embossing section 150 so that the tape T pulled from the tape cartridge C can be directly subjected to braille embossing. Ink-character printing and braille embossing may be performed on the basis of different character information instead of the same character information.

In the layout setting step (S30), based on the results of tape width detection (S11) and process mode selection (S13), the relative position between the ink-character printing area (printing arrangement section) Ep and the braille-embossing area (embossing arrangement section) Eb on the tape T (see FIGS. 9A to 9C) and the lengths of the arrangement sections (the printing arrangement section, the embossing arrangement section, and the common arrangement section) are set as the main settings. In addition, other settings, such as the character size for ink-character printing, similar to those of common tape-printing apparatuses and word processors are also made.

As an example, a case in which the first process mode (both ink and braille characters) is selected will be described below. Referring to FIG. 9A, if the result of tape width detection is 24 mm (tape T1), a layout in which the printing arrangement section Ep is above the embossing arrangement section Eb (layout (a-1) in which the braille characters are on the lower line) or a layout in which the printing arrangement section Ep is below the embossing arrangement section Eb (layout (a-2) in which the braille characters are on the upper line) is selected.

Referring to FIG. 9B, also when the tape width is 18 mm (tape T2), a layout (b-1) in which the braille characters are on the lower line or a layout (b-2) in which the braille characters are on the upper line is selected. In this case, the size of the printing arrangement section Ep along the width of the tape T is reduced in accordance with the tape width. When tape T1 or tape T2 is selected, instead of arranging the ink and braille characters parallel to each other (hereafter called an ink/braille parallel arrangement), the ink characters may be printed in an arbitrarily (for example, increased) size and the braille characters may be formed so as to overlap the ink characters (hereafter called an ink/braille overlapping arrangement).

Referring to FIG. 9C, when the tape width is 12 mm (tape T3), the tape width corresponds to a minimum width that allows the braille cells 201 to be embossed (see FIG. 4A). Therefore, irrespective of whether the braille characters are set to be arranged on the upper or lower line and irrespective of whether the ink/braille parallel arrangement or the ink/braille overlapping arrangement is selected, a layout in which the printing arrangement section Ep and the embossing arrangement section Eb are superimposed on each other is used.

In the label-making apparatus 1, a preview display screen (preview screen and monitor screen) can be shown on the display 4 in addition to normal screens such as a text editing screen. In the preview display step (S31 in FIG. 7), the image of the result of ink-character printing and braille embossing obtained if ink-character printing and braille embossing are performed with the current settings is displayed on the monitor screen of the display 4 (preview display).

Next, the symbol input step (S33) will be described below. As an example, a case in which braille information is input or created in response to the symbol input command (depression of the symbol key) will be explained in detail.

In the step of inputting the character information (S12), the label-making apparatus 1 can place (insert) symbols (hereafter sometimes called “signs”) including pictograms, external symbols, and simple diagrams in the ink character strings and print them together with the ink character strings. Although the signs inserted in the ink character strings are for sighted people, when the signs for sighted people are input or selected, they are submitted to braille conversion (braille transcription) to obtain braille information (symbol-to-braille transciption) of the braille strings corresponding to the signs (braille data including braille transcription character strings and cell images of the braille strings).

The symbols (signs) registered and usable in the label-making apparatus 1 are classified into a plurality of categories depending on the places and conditions of use (hereafter simply called “use”). More specifically, each sign is registered (stored) as bitmap font data in association with the corresponding category. Signs registered before shipment and signs added afterwards and subjected to ROM transcription (or ROM conversion) are stored in the control data block 222 of the ROM 220, and other additional signs are stored in the work area block 236 in the RAM 230.

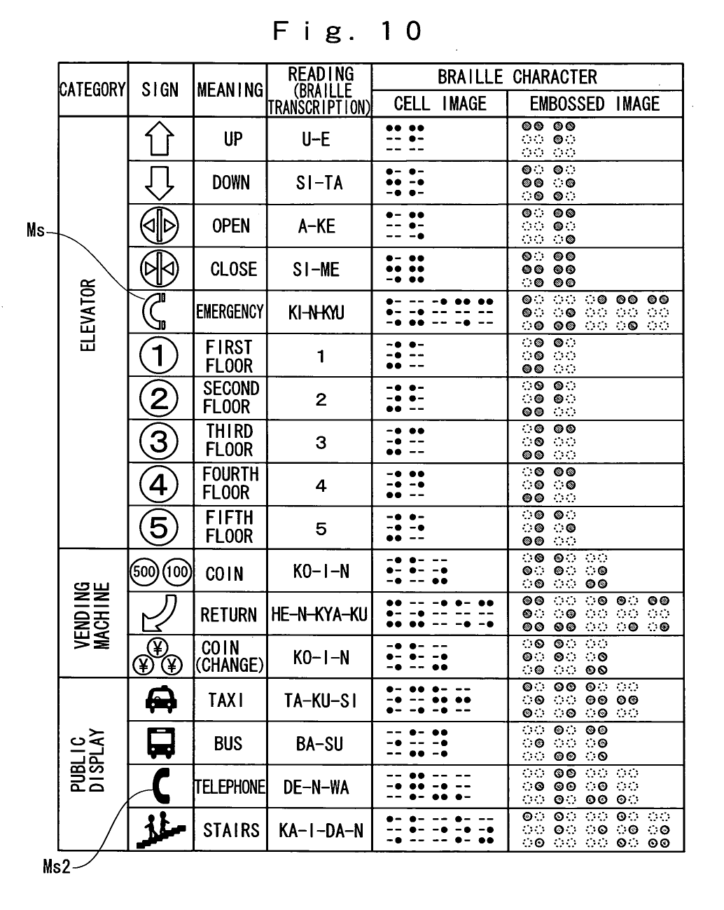

The classification categories may include, for example, “elevator”, “vending machine”, and “public display” as listed in the column “category” in FIG. 10. In addition, the classification categories may also include “description”, “abbreviation”, “bracket”, “arrow”, “OΔ□*”, “unit”, “arithmetic”, “number”, “two-digit number”, “environment”, “baggage”, “warning”, “business”, “sport”, “amusement”, “video”, “music”, “living creature”, “vehicle”, “food”, “plan”, “living”, “season”, “family”, “animal zodiac”, “constellation”, “Greek”, “Europe”, “edit”, etc. Although the column “category” in FIG. 10 includes other various categories in addition to those shown in FIG. 10, only categories described in the present embodiment and some of the signs that belongs to the categories are shown.

In the label-making apparatus 1, the control data block 222 or the work area block 236 stores kana character strings used in “symbol-to-braille transcription” that indicate the reading of the signs classified into categories and to which the braille specifications, such as long-form conversion, are already applied. The kana character strings are stored (registered) in association with the corresponding categories and signs.

The information of the braille transcription character strings may be stored as the associating information of the corresponding signs. In this case, there is an advantage that each sign and the corresponding braille transcription character string can be read out together. Alternatively, the braille transcription character strings may be stored separately from the corresponding signs and a table or the like for associating them with each other may be prepared. In such a case, there is an advantage in that storage regions can be easily prepared since the braille transcription character strings and the signs are stored separately from each other.

In the present embodiment, when an ink character string is input (S12 in FIG. 7), the ink character string is subjected to braille transcription based on the braille specifications such as space insertion, long-form conversion, and particle conversion to obtain a corresponding braille transcription character string. Then, the braille transcription character string is subjected to braille conversion to obtain a cell image of braille characters. Accordingly, braille image data of a braille string is obtained. Similarly, in symbol-to-braille transcription, data of braille transcription character strings (text data or the like) is registered in advance and is subjected to braille conversion as necessary. However, as shown in FIG. 10, data of corresponding cell images and embossed images (image data) may also be registered. In such a case, although a larger memory is required compared to the case in which only the text data of braille transcription character strings is registered, a control process for displaying a cell image corresponding to a selected sign or performing braille embossing can be more easily and quickly performed.

In the present embodiment, similar signs that belong to different categories (for example, a telephone sign Ms belonging to the category “elevator” and a telephone sign Ms2 belonging to the category “public display”) are shown differently for convenience in explanation and to facilitate understanding. However, even if the signs are identical, they are registered (stored) individually under different categories.

Accordingly, it is understood (recognized) that although the “telephone” sign in the category “public display” literally means a telephone, the “telephone” sign in the category “elevator” has a meaning of emergency contact means rather than simply a telephone. Therefore, in the category “elevator”, the meaning of the “telephone” sign is “emergency”.

Next, an operation of acquiring braille information of a braille string representing a common expression that corresponds to a sign for sighted people in accordance with the use (category) thereof will be described in detail below.

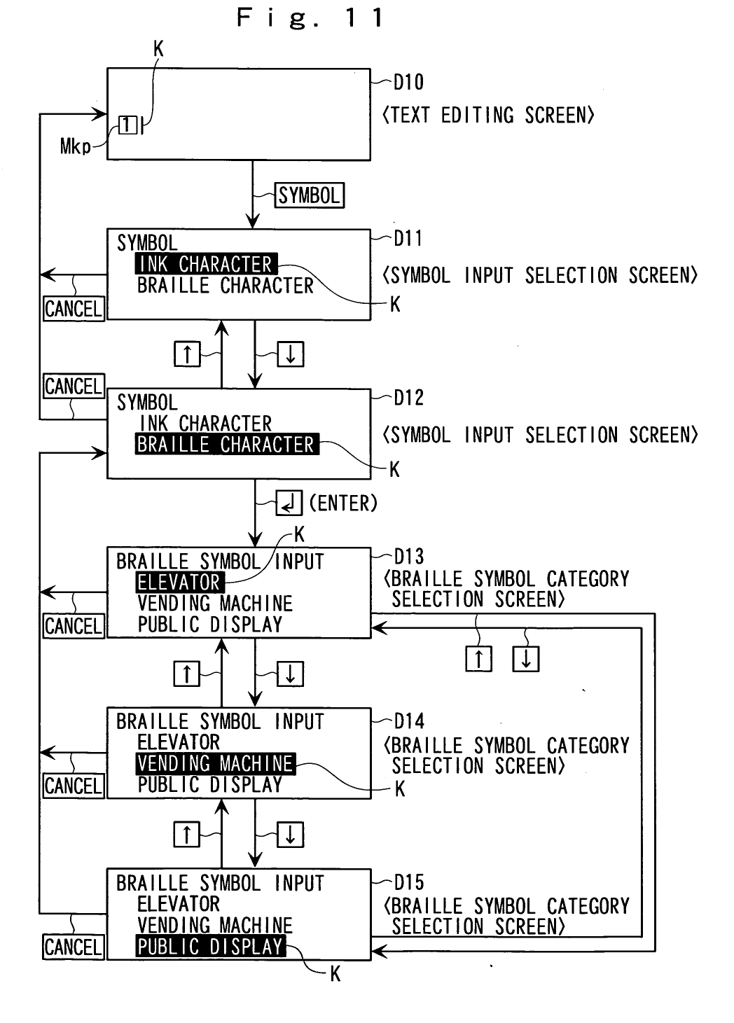

Referring to FIG. 11, first, in the initial state before starting to edit text, the line number of the first line at which text editing is started (ink character sign Mkp) is displayed. In addition, a cursor K for prompting the user to input the first character on the first line is displayed (text editing screen D10). In the following descriptions and drawings, the states of the screen on the display 4 are denoted by Dxx.

From the initial state (D10), when the user presses the symbol key (symbol input command interruption (INTS) in FIG. 7), the symbol input step is executed (S33). Accordingly, to input a symbol, the display screen changes to a first-hierarchy selection screen (symbol input selection screen D11). In the label-making apparatus 1, the user can press a delete key (used to delete one character at a time) or a cancel key to cancel various commands of key input or input data, thereby returning to the previous state. The explanation of this will be omitted.

In the above-described state (D11), “ink character” or “braille character” can be selected and designated by operating the cursor depending on whether to input symbols for ink characters or symbols for braille characters (that is, symbols to be subjected to braille conversion). In the state immediately after the screen change, the previously selected item is designated as default by the cursor (the initial setting is “ink character”). Similarly, in each of the screens described below, the cursor designates the previously selected items as default in the state immediately after the screen change.

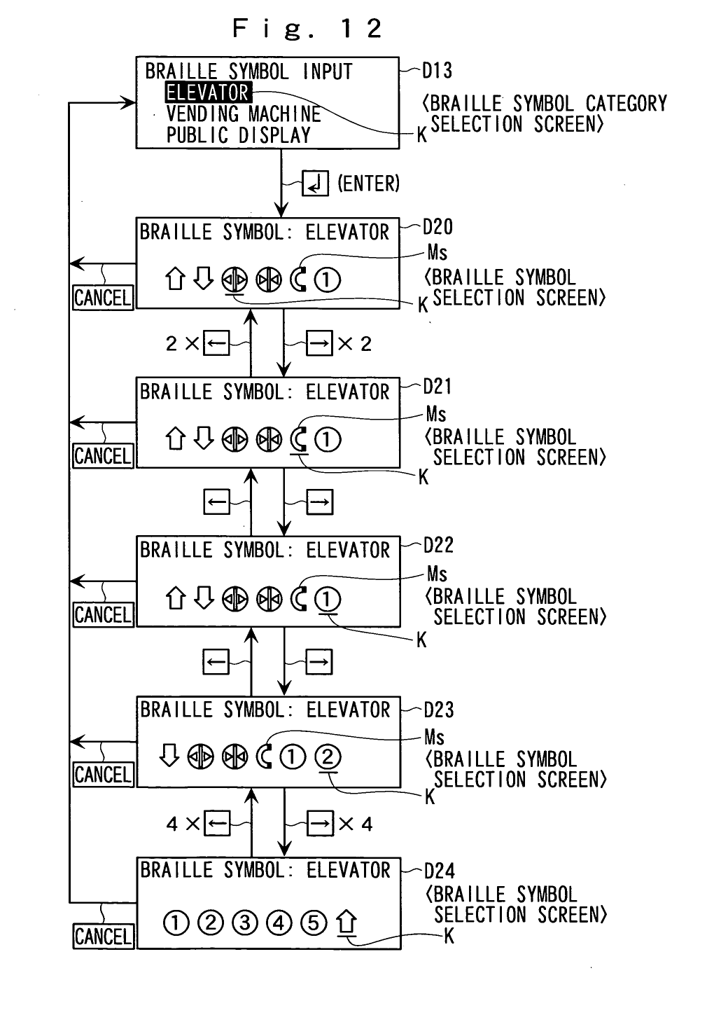

In this example, a symbol for braille characters is to be input. Therefore, the cursor is moved downward from the above-described state (D11) so that “braille character” is designated by the cursor (D12). Then, the Enter key is pressed to select “braille character” (hereafter simply called “selection confirmation”), so that “braille character” is set as a symbol input method (symbol input mode). Then, the screen changes to a braille symbol category selection screen D13 (D13 is shown in both FIGS. 11 and 12).

In this state, one of “elevator”, “vending machine”, and “public display” can be selected and designated as the classification category by moving the cursor upward or downward (D13 to D15). In this example, as shown in FIG. 12, “elevator” is selected and confirmed (D13), and is set as the classification category. Accordingly, the screen changes to a braille symbol selection screen D20 corresponding to the category “elevator”.

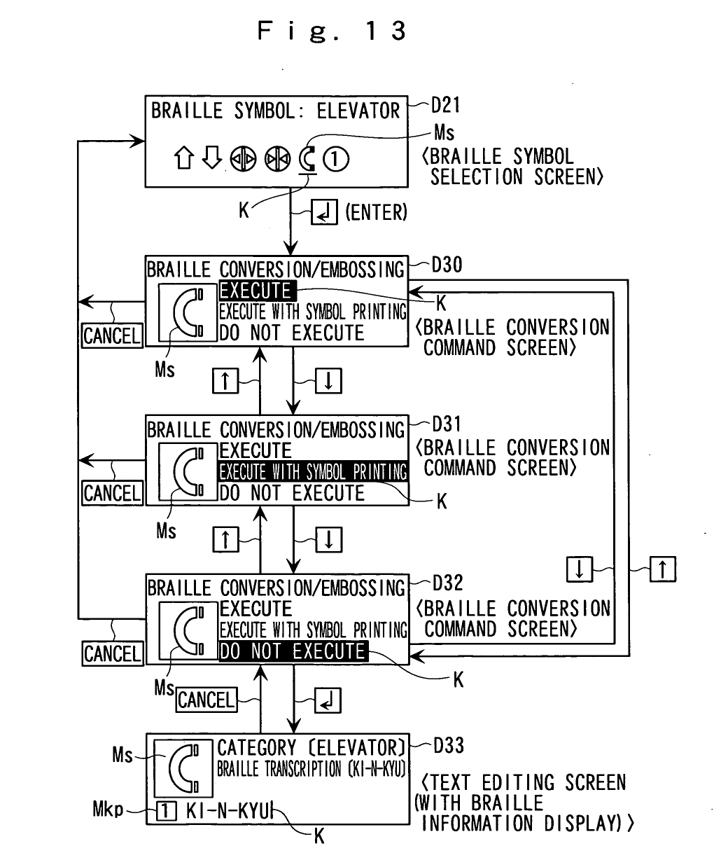

In this state, one of the symbols (signs) belonging to the designated category “elevator” shown in FIG. 10 can be selected and designated by moving the cursor rightward or leftward (D20 to D24: D21 is also shown in FIG. 13). In this example, as shown in FIG. 13, the “telephone” sign Ms, which means “emergency”, is selected and confirmed (D21). Accordingly, the telephone sign Ms is set as the selected sign, and the screen changes to a braille conversion command screen D30 for selecting a process of braille information corresponding to the selected sign, i.e., for selecting whether or not to make a braille label.

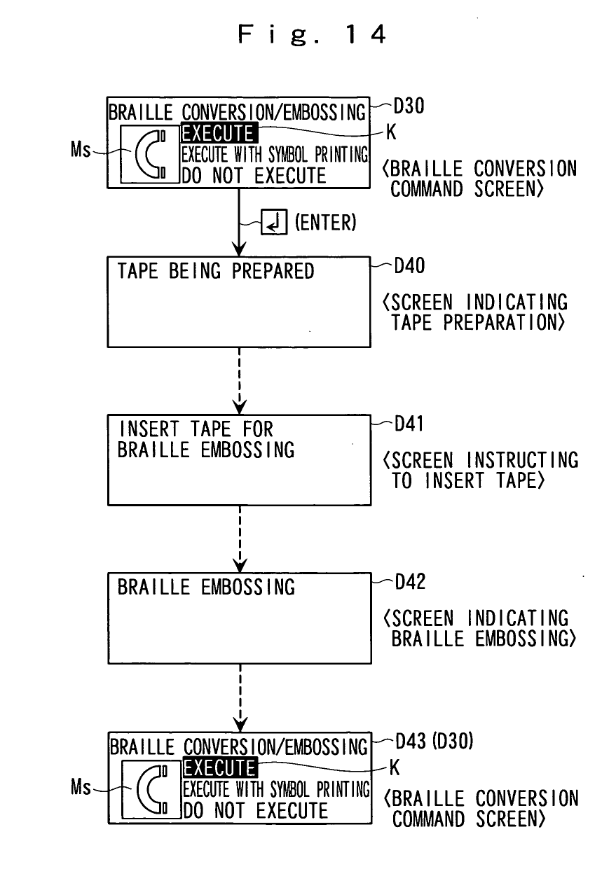

In this state, one of “execute”, “execute with symbol printing”, and “do not execute” can be selected and designated by moving the cursor upward or downward (D30 to D32: D30 is also shown in FIG. 14). When “execute” is selected, braille embossing of a braille string representing a common expression corresponding to the telephone sign Ms in the category “elevator” is performed. In this example, the meaning of the telephone sign Ms is “emergency” and the braille transcription thereof is “ki-n-kyu” in kana characters. When “execute with symbol printing” is selected, braille embossing and printing of the sign are both performed. When “do not execute” is selected, neither of braille embossing and printing of the sign is performed.

In this example, as shown in FIG. 14, “execute” is selected and confirmed (D30), so that braille embossing of a braille string representing the common expression (“ki-n-kyu”) that corresponds to the telephone sign Ms is performed. In this case, the third process mode (only braille embossing) described with reference to FIGS. 7 and 8C is performed. More specifically, first, a message “tape being prepared” is displayed while blank printing and tape cutting/output are performed (D40 in FIG. 14, S22 and S23 in FIG. 7). Then, an instruction to insert the tape is displayed (D41, S24).

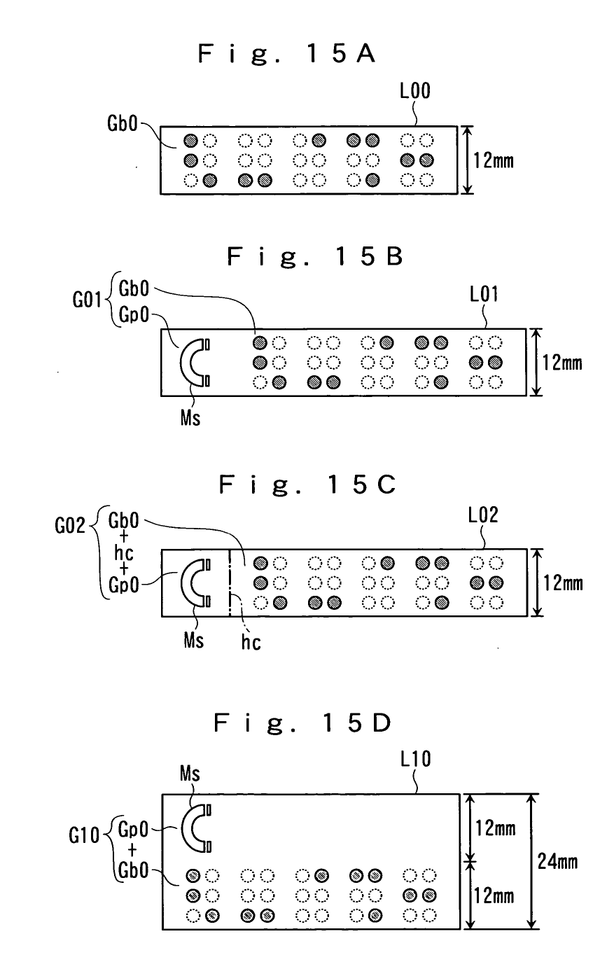

Then, when the tape T is inserted into the embossing-tape insertion slot 31, a message “braille embossing” is displayed and braille embossing is performed in accordance with the braille information of the braille string representing the common expression (“ki-n-kyu”) corresponding to the telephone sign Ms. In this example, the braille information is a braille image (data) Gb0 of the embossed image (see FIG. 15A). Then, the tape T is output (D42, S25 and S26), and the process is finished (S27). Then, the screen returns to the initial selection screen D43 (identical to D30). Accordingly, as shown in FIG. 15A, when the tape width is 12 mm, a label L00 on which braille characters are embossed is obtained.

As described with reference to FIG. 2, the tape T includes the base tape (base sheet) Tb having an adhesive agent layer (adhesive layer) on the back surface thereof and the peel tape (peel sheet) Te adhered to the base tape Tb so as to cover the adhesive agent layer. Accordingly, after checking the label L00 and confirming (recognizing) the braille string (cell image, embossed image) corresponding to the telephone sign Ms in the category “elevator”, the label can be adhered at a desired location that matches the category (for example, near a telephone installed in the elevator).

After the label is made and the screen is returned to the braille conversion command screen D43 (identical to D30), or if “do not execute” is selected and confirmed on the braille conversion command screen D32 shown in FIG. 13, the screen changes to a text editing screen D33. This screen displays the selected category (elevator), the sign (telephone sign Ms), and the braille information (braille transcription character string) of the common expression corresponding to the sign (“ki-n-kyu”). In addition, the expression “ki-n-kyu” is displayed as a part of the ink character string so that it can be directly input as the ink character string, and the cursor K is displayed for prompting the user to input the next character (D33).

As described above, in the label-making apparatus 1 according to the present embodiment, various signs seen by sighted people in daily lives are classified into categories designating the use thereof, and a desired sign (for example, the telephone sign Ms in the above-described example) can be selected to check a common braille expression corresponding to the sign.

In the above-described example, the braille image (braille information) Gb0 showing the embossed image of the braille string representing the common expression “ki-n-kyu” that corresponds to the telephone sign Ms in the category “elevator” (that is, a braille string representing a common expression that corresponds to each sign in each category) is read out by selecting the telephone sign Ms and is embossed on the tape T. In other words, the braille image is read out and presented by selecting a desired sign.

In the above-described example, by checking the label L00, even a sighted person who does not have knowledge of braille specifications and common braille expressions can acquire the braille information of braille strings representing common expressions that correspond to signs for sighted people in accordance with the use thereof (that is, depending on the categories to which the signs belong).

Accordingly, the label-making apparatus 1 functions as if it is a “sign/common-braille-expression dictionary” that provides braille information of braille strings representing common expressions that correspond to signs for sighted people.

In the above-described example, the embossed image of the braille string representing the common expression “ki-n-kyu” that corresponds to the telephone sign Ms in the category “elevator” (that is, the cell image of a braille string representing a common expression that corresponds to each sign in each category) can be recognized by checking the tape (processing sheet) T, i.e., the label L00 on which the braille string is embossed (in other words, on which the braille information is presented by braille embossing).

When the above-described example is a first example, only embossing of the braille string representing the common expression “ki-n-kyu” is performed in the first example. However, in addition to braille embossing, the telephone sign Ms may also be printed on the tape (process sheet) T. This will be explained in more detail below as a second example.

In the second example, “execute with symbol printing” is selected and confirmed on the braille conversion command screen D31 shown in FIG. 13. In this case, printing of the telephone sign Ms is set to be performed in addition to braille embossing of the braille string representing the common expression “ki-n-kyu” that corresponds to the telephone sign Ms in the category “elevator”. Accordingly, the first process mode (both ink and braille characters) described with reference to FIGS. 7 and 8A is performed.

More specifically, first, a message “sign printing” is displayed instead of the message “tape being prepared” in FIG. 14, and printing (ink-character printing) is performed to form an ink-character image (image data) Gp0 (see FIG. 15B) of the telephone sign Ms. Then, the tape is cut and output (S15 and S16 in FIG. 7), and the instruction to insert the tap is displayed (identical to D41 in FIG. 14, S17 in FIG. 7).

Then, when the tape T is manually inserted for braille embossing, the message “braille embossing” is displayed and braille embossing is performed on the basis of the braille image Gb0 of the common expression “ki-n-kyu”. Then, the tape T is output (identical to D42, S18 and S19), the process is finished (S27), and the screen returns to the initial selection screen (identical to D31). Accordingly, as shown in FIG. 15B, when the tape width is 12 mm, a label L01 having an appearance (image) G01 obtained by printing the telephone sign Ms and embossing the braille string representing “ki-n-kyu” is obtained.

In this case, the telephone sign Ms and the braille string representing the common expression “ki-n-kyu” that corresponds to the telephone sign Ms in the category “elevator” (that is, the sign on the process sheet and the corresponding braille string) can be recognized in association with each other simply by checking the label L01 formed of the tape T.

In addition, also in this case, the tape T includes the base tape (base sheet) Tb and the peel tape (peel sheet) Te adhered to the base tape Tb so as to cover the adhesive agent layer (adhesive layer) thereof (see FIG. 2). Accordingly, after recognizing the telephone sign Ms and the braille string that represents the corresponding common expression “ki-n-kyu” on the tape (process sheet) T, the base tape Tb can be separated from the peel tape Te and be adhered at a desired location that matches the category (for example, near a telephone installed in the elevator) as the label L01 showing both the sign and the braille string (mixed label).

In the label-making apparatus 1, the half cutter 144 (see FIG. 3) can cut only the base tape Tb (half-cut) in the ink-character-printing process. Therefore, as shown in FIG. 15C, when ink-character printing of the telephone sign Ms is performed, the tape T can be half-cut along a half-cut line hc between the ink-character printing area and the braille-embossing area. Then, similar to FIG. 15B, braille embossing is performed. As a result, as shown in FIG. 15C, a label L02 having an appearance (image) G02 is obtained.

In this case, similar to the above-described label L01, the telephone sign Ms and the braille string that represents the corresponding common expression “ki-n-kyu” on the tape (process sheet) T can be recognized. Then, a portion of the base tape Tb including the ink-character image Gp0 of the telephone sign Ms and a portion of the base tape Tb including the braille image Gb0 of the braille string representing “ki-n-kyu” can be individually or simultaneously separated from the peel tape Te and be adhered at a desired location (for example, near a telephone installed in the elevator) as a sign label, a braille label, or a mixed label.

Although the tape T with the width of 12 mm (tape T3) is used to produce the labels in the above-described examples, labels may also be produced in a similar manner using the tape T with the width of 24 mm (tape T1) or 18 mm (tape T2). In addition, instead of arranging the ink-character image Gp0 of the telephone sign Ms and the braille image Gb0 of the braille string representing “ki-n-kyu” along the length of the tape T as shown in FIG. 15B, they may be arranged in parallel along the width of the tape T to make a label L10 having an appearance (image) G10 shown in FIG. 15D.

In addition, in the above-described first and second examples, the braille information is input and created by performing “symbol-to-braille transcription” in response to the symbol input command (depression of the symbol key). However, the braille information can also be obtained using a braille input command (depression of the braille input key). This will be explained in more detail below as a third example.

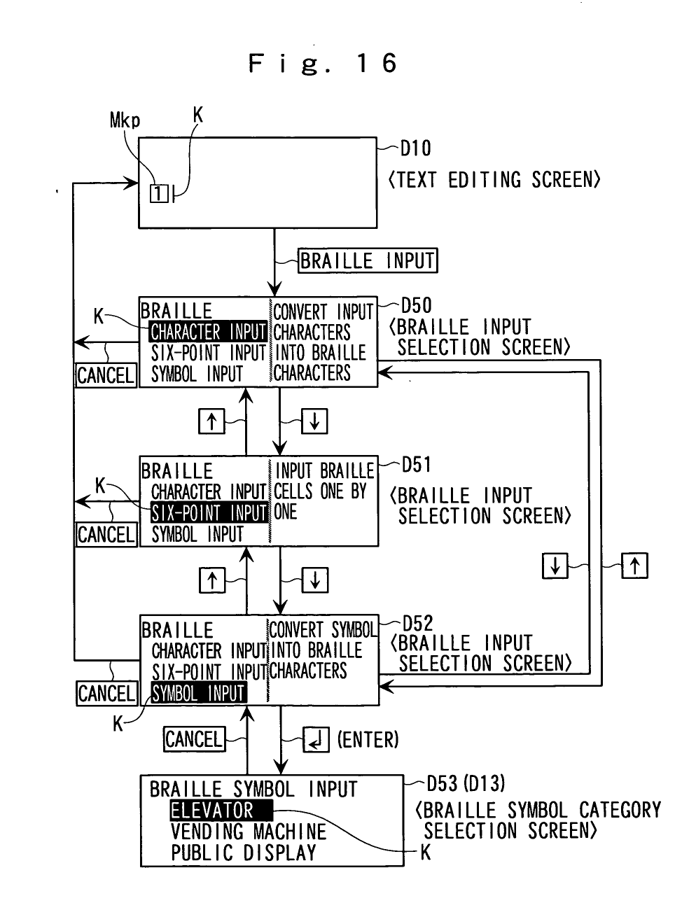

Referring to FIG. 16, in the third example, the braille input key is pressed while the text editing screen D10 (identical to D10 in FIG. 11) is shown (braille input command interruption (INTB) in FIG. 7). Accordingly, the braille input process is activated (S32). To input braille characters, the screen changes to a first-hierarchy selection screen (braille input selection screen) D50.

In this state (D50), “character input”, “six-point input”, and “symbol input” can be selected and designated by operating the cursor (D50 to D52). When “character input” is selected, an ink character string is input and is subjected to braille transcription to input braille characters. When “six-point input” is selected, braille characters (braille cells) are input by designating each of the dots to be embossed. When “symbol input” is selected, braille characters are input on the basis of the symbol input (symbol selection).

In this example, “symbol input” is selected and confirmed by moving the cursor upward or downward (D52). Accordingly, the screen changes to a braille symbol category selection screen D53 (identical to D13 in FIG. 11).

From this state (D53), steps similar to the steps described above with reference to FIGS. 11 to 14 (D13 to D15, D20 to D24, and D30 to D33) are performed to produce labels similar to the above-described labels L00, L01, L02, and L10 shown in FIGS. 15A to 15D according to the first and second examples.

Therefore, simply by checking this label, even a sighted person who does not have knowledge of braille specifications and common braille expressions can acquire the braille information of braille strings representing common expressions (for example, “ki-n-kyu”) that correspond to signs for sighted people (telephone sign Ms) in accordance with the use (category) thereof. Accordingly, the label-making apparatus 1 functions as if it is a “sign/common-braille-expression dictionary” that provides braille information of braille strings representing common expressions that correspond to signs for sighted people.

In the above-described first to third examples, the braille information is a braille cell image (hereafter includes “embossed image”) and is presented to the user by braille embossing (i.e., by making the braille label). However, instead of braille embossing, the braille information may also be presented to the user by printing.

This will be explained in more detail below as a fourth example. In the fourth example, the braille information is presented by printing. For example, the labels shown in FIGS. 15A to 15D may be obtained by ink-character printing only. More specifically, FIGS. 15A to 15D show images of braille cells including embossed and non-embossed dots. In the fourth example, the labels are made by performing the second process mode (only ink characters) described above with reference to FIGS. 7 and 8B on the basis of the braille information representing the ink-character images (data) shown in FIGS. 15A to 15D.

Therefore, simply by checking the label obtained by ink-character printing, that is, simply by checking the braille information printed on the tape (process sheet) T, even a sighted person who does not have knowledge of braille specifications and common braille expressions can acquire the braille information of braille strings representing common expressions (for example, “ki-n-kyu”) that correspond to signs for sighted people (telephone sign Ms) in accordance with the category thereof. Thus, the apparatus functions as a “sign/common-braille-expression dictionary”.

In this case, since the braille information is presented by printing, the braille information may also be a braille transcription character string instead of the cell image (embossed image). More specifically, in the above-described labels, the character string “ki-n-kyu” may also be printed instead of the embossed image (braille image Gb0).

Accordingly, by presenting the braille information (the braille transcription character string in this case), the reading of the braille strings corresponding to the signs classified into categories can be recognized. In addition, since the label-making apparatus 1 can make a braille label on the basis of an ink character string, braille labels (braille sheets) corresponding to the signs classified into categories can also be obtained by inputting the recognized braille transcription character strings as the ink character strings.

In addition, the braille information may also be presented simply by displaying the braille information instead of performing braille embossing or printing. This will be described in more detail below as a fifth example. Also in the fifth example, the braille information may either be the cell image or the braille transcription character string.

When “do not execute” is selected and confirmed on the braille conversion command screen D32 shown in FIG. 13, the screen changes to the text editing screen D33. In this state, the selected category (elevator), the sign (telephone sign Ms), and the braille information (braille transcription character string) of the corresponding common expression “ki-n-kyu” are displayed. Therefore, even if the label is not made, the braille transcription character string of the braille information can be recognized from this display (presentation) and the apparatus functions as a “sign/common-braille-expression dictionary”.

Labels similar to those shown in FIGS. 15A to 15D can, of course, also be obtained by inputting the braille transcription character string “ki-n-kyu” shown on the display as the ink character string. In the label-making apparatus 1, when the screen changes to the text editing screen D33, “ki-n-kyu” is displayed as a part of the ink character string so that it can be directly input as the ink character string, and the cursor K is displayed for prompting the user to input the next character. Accordingly, user-friendliness is increased.

More specifically, in a normal process performed when an ink character string is input and the braille transcription key is pressed, braille transcription from the ink character string to a braille transcription character string and braille conversion from the braille transcription character string to braille characters (cell image) are performed. However, in this case, a braille transcription character string to which the braille specifications, such as long-form conversion, for braille transcription are already applied is input as the ink character string. In other words, the ink character string is the same as the braille transcription character string, i.e. “ki-n-kyu”, and is directly subjected to braille conversion. Accordingly, the braille image similar to that shown in FIGS. 15A to 15D is obtained and labels similar to those shown in FIGS. 15A to 15D can be obtained.

In addition, since the apparatus is in the text editing state (S12 in FIG. 7), the first process mode (both ink and braille characters), the second process mode (only ink characters), and the third process mode (only braille characters) can be arbitrarily selected. Accordingly, each of the labels shown in FIGS. 15A to 15D can be easily produced.

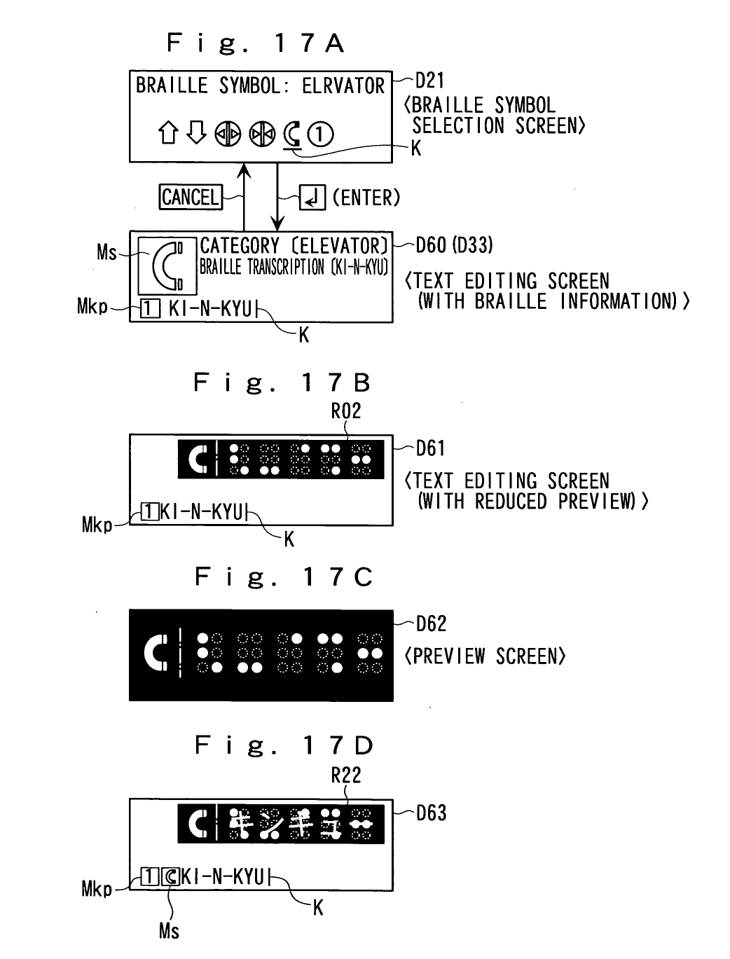

Therefore, as shown in FIG. 17A, the braille symbol selection screen D21 can be directly changed to a text editing screen D60 (identical to D33 in FIG. 13) showing braille information by omitting the braille conversion command screens in FIG. 13.

In addition, as shown in FIG. 17B, the braille transcription character string “ki-n-kyu” may also be displayed only in the input line of the ink character string in a text display screen (D61). Instead of displaying the braille transcription character string in an upper section of the screen, a reduced preview section (R02) showing a label (for example, the label L02 shown in FIG. 15C) that can be obtained by pressing the print key and issuing the print/execute command (INTG in FIG. 7).

In addition, the text editing screens D60 and D61 shown in FIGS. 17A and 17B can be switched to a corresponding preview screen D62 shown in FIG. 17C by pressing the preview key and issuing the preview display command (INTR in FIG. 7).

In the above-described fifth example, by checking the braille information (the cell image or the braille transcription character string) displayed on the display screen, even a sighted person who does not have knowledge of braille specifications and common braille expressions can acquire the braille information (the cell image or the braille transcription character string) of braille strings representing common expressions (for example, “ki-n-kyu”) that correspond to signs for sighted people (telephone sign Ms) in accordance with the category (elevator) thereof. Thus, the apparatus functions as a “sign/common-braille-expression dictionary”.

In addition to the first to fifth examples, other various modifications can be made. These modifications will be described below as a sixth example.

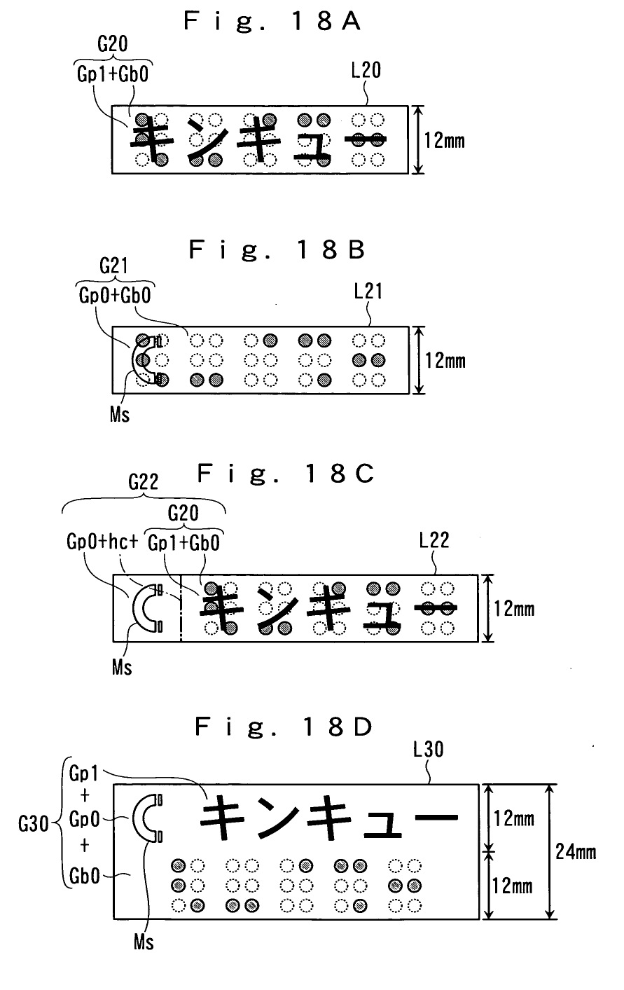

For example, the label L00 shown in FIG. 15A is obtained using the third process mode (only braille characters). However, as shown in FIG. 18A, when the first process mode (both ink and braille characters) is used, a label L20 having an appearance (image) G20 obtained by printing the ink-character image Gp1 of the braille transcription character string “ki-n-kyu” and embossing the corresponding braille image Gb0 can also be obtained. Accordingly, the braille transcription character string “ki-n-kyu” and the cell image thereof included in the braille information of the braille string representing the common expression can be recognized at the same time by checking the label L20.

In addition, in the label L01 shown in FIG. 15B, ink-character printing of the ink-character image Gp0 of the telephone sign Ms and braille embossing of the braille image Gb0 representing “ki-n-kyu” are performed at different positions. However, since braille characters do not appear as clearly as they do in the figures in practice, a label L21 shown in FIG. 18B in which the sign and the braille string overlap each other may also be obtained. Also in this case, the telephone sign Ms and the braille information (cell image) of the braille string representing the corresponding common expression “ki-n-kyu” can be recognized at the same time by checking the label L21.

FIG. 18C shows a label L22 obtained by performing ink-character printing of the braille transcription character string representing the common expression “ki-n-kyu” such that the braille transcription character string overlaps with the braille string in the label L02 shown in FIG. 15C. This label L22 can be obtained using the first process mode (both ink and braille characters) by performing ink-character printing of the telephone sign Ms and the braille transcription character string “ki-n-kyu” and then performing braille embossing.

FIG. 18D shows a label L30 obtained by additionally printing the braille transcription character string “ki-n-kyu” in the ink-character printing area of the label L10 shown in FIG. 15D. The label L30 can also be produced using the first process mode (both ink and braille characters).

Accordingly, the telephone sign Ms and the braille information (both the braille transcription character string and the cell image) of the braille string representing the corresponding common expression “ki-n-kyu” can be recognized at the same time by checking the label L22 or L30.

In each of the labels shown in FIGS. 18A to 18D, braille embossing of the braille image Gb0 is performed. However, the braille image Gb0 may also be combined as an ink-character printing image and be printed as it is shown in FIGS. 18A to 18D using the second process mode (only ink characters). Also in this case, similar to the above-described cases in which braille embossing is performed, the telephone sign Ms and the braille information (both the braille transcription character string and the cell image) of the braille string representing the corresponding common expression “ki-n-kyu” can be recognized at the same time by checking the labels on which only the ink characters are formed.

In addition, as shown in FIG. 17D, a text editing screen D63 including a reduced preview section (R22) showing the label of, for example, FIG. 18C may be displayed in place of the above-described text editing screens D60 and D61. In such a case, the telephone sign Ms and the braille information (both the braille transcription character string and the cell image) of the braille string representing the corresponding common expression “ki-n-kyu” can be recognized at the same time by checking the display screen.

In addition, when the telephone sign Ms and the braille transcription character string “ki-n-kyu” are arranged in the input line of the ink character string in the text editing screen D63, as shown in FIG. 17D, the ink character string can be easily input. In addition, even if the reduced preview section is small and not clear, the ink character string can be easily recognized in the input line thereof.

In the above-described embodiment, the telephone sign Ms indicates a telephone installed in the elevator. This type of telephone includes, of course, an intercom telephone that does not have an earphone.

In addition to the above-described expression “ki-n-kyu”, various other expressions including “i-jyo-u” and “hi-jyo-u” are used as the common expression that corresponds to the telephone sign Ms depending on the elevator manufacturer. Therefore, it is desirable to standardize braille expressions, not only to increase the convenience of making braille labels corresponding to signs but also to prevent visually impaired people from being confused. If a standard of braille expressions is established, the label-making apparatus 1 is configured to comply with such standard.

In reverse, if braille-information-processing apparatuses like the label-making apparatus 1 according the above-described embodiment that functions as the “sign/common-braille-expression dictionary” comes into widespread use, it will promote unification and standardization of braille expressions and contribute to improve the lives of visually impaired people.

A braille-information-processing apparatus that provides the functions and the processing methods including the braille-information-processing method according to the above-described embodiment is not limited to the label-making apparatus 1. More specifically, the invention may also be applied to programs processed by various program processing apparatuses capable of processing the programs and storage media for storing the programs. Such a program may be stored or read out from a storage medium, and be executed to allow sighted people who do not have knowledge of braille specifications or common braille expressions to acquire braille information of braille strings representing common expressions that correspond to signs for sighted people in accordance with the use thereof.

Compact disk read-only memories (CD-ROM), flash ROM, memory cards (compact-flash® cards, smart media, memory sticks, etc.), compact disks, magneto-optical disks, digital versatile disks, and flexible disks may be used as the above-described storage media. Other kinds of storage media may, of course, also be used within the scope of the invention.

What is claimed is:

1. A braille-information-processing apparatus comprising:
a sign-storing device that stores a plurality of kinds of signs for sighted people, the signs being classified into a plurality of categories in accordance with the use of the signs and stored in association with the corresponding categories;
a braille-information-storing device that stores braille information of a braille string representing a common expression that corresponds to each sign in each category, the braille information being stored in association with the corresponding sign and category;
a sign-selecting device that selects one of the categories and one of the signs belonging to the selected category; and
a presenting device that presents the braille information corresponding to the selected sign.

2. The braille-information-processing apparatus according to claim 1, wherein the braille information includes cell image information representing an arrangement of cells of the braille string.

3. The braille-information-processing apparatus according to claim 2, wherein the presenting device includes an embossing device that embosses the braille string on a process sheet on the basis of the cell image information.

4. The braille-information-processing apparatus according to claim 3, wherein the presenting device includes a sign-printing device that prints the selected sign on the process sheet such that the sign and the embossed braille string are adjacent to or overlapped with each other.

5. The braille-information-processing apparatus according to claim 4, wherein the process sheet includes a base sheet having an adhesive layer on one side and a peel sheet that covers the adhesive layer, and
wherein the braille-information-processing apparatus further includes a half cutter that cuts only the base sheet at a position between the embossed braille string and the printed sign.

6. The braille-information-processing apparatus according to claim 1, wherein the braille information includes braille-transcription-character-string information representing a braille transcription character string that represents the reading of the braille string.

7. The braille-information-processing apparatus according to claim 1, wherein the presenting device includes a braille-information display that displays the braille information on a display screen.

8. The braille-information-processing apparatus according to claim 1, wherein the presenting device includes a braille-information printer that prints the braille information on a process sheet.

9. A method for processing braille information, comprising:
storing a plurality of kinds of signs for sighted people, the signs being classified into a plurality of categories in accordance with the use of the signs and stored in association with the corresponding categories;
storing braille information of a braille string representing a common expression that corresponds to each sign in each category, the braille information being stored in association with the corresponding sign and category;
selecting one of the categories and one of the signs belonging to the selected category; and
presenting the braille information corresponding to the selected sign.

10. A process sheet comprising:
a sign printed thereon, the sign being selected from a plurality of signs for sighted people that are classified into a plurality of categories in accordance with the use of the signs; and
a braille string of a common expression corresponding to the printed sign, the braille string being embossed or printed such that the sign and the braille string are adjacent to or overlapped with each other.

11. The process sheet according to claim 10, wherein the process sheet includes a base sheet having an adhesive layer on one side and a peel sheet that covers the adhesive layer, the sign and the braille string being arranged on the base sheet.

12. The process sheet according to claim 11, wherein only the base sheet is cut by a half-cut process at a position between the sign and the braille string.

13. A program for causing the braille-information-processing apparatus according to any one of claims 1 to 8 to function.

14. A storage medium that stores the program according to claim 13 such that the program can be read by an apparatus that is capable of processing the program.
